(19) United States
(12) Patent Application Publication
(10) Pub. No.: US 2001/0005134 A1
(43) Pub. Date: Jun. 28, 2001

(54) Circuit configuration compensating for disturbance variables for a measurement pickup

(76) Inventors: Jorg Friedel, Wenzenbach/Grunthal (DE); Ludwig Schifferl, Pentling (DE)

Correspondence Address: LERNER AND GREENBERG, P.A., POST OFFICE BOX 2480, HOLLYWOOD, FL, 33022-2480, US

(21) Appl. No.: 09/737,059

(22) Filed: Dec. 14, 2000

(30) Foreign Application Priority Data
Dec. 14, 1999 (DE) 199 60 301.4

(51) Int. Cl. G01N 27/72

(52) U.S. Cl. 324/225; 324/252

(57) ABSTRACT

A circuit configuration compensates for disturbance variables in a measurement pickup which has a measured-variable dependent resistance that is added from a fundamental resistance, which is independent of measured variables, and a measuring resistance, which is dependent on measured variables. The fundamental resistance and the measuring resistance are disturbance variable-dependent in opposite directions. A bridge circuit has two measurement pickups using difference evaluation to eliminate the disturbance variable dependency of the fundamental resistance. A bridge voltage controller sets the bridge diagonal voltage in the opposite direction to the disturbance variable dependency of the measuring resistance, and thus compensates for the disturbance variable-dependency of the measuring resistance.

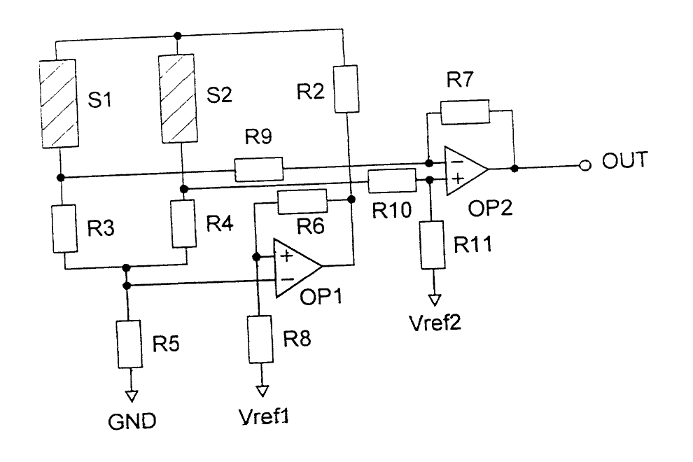

### BACKGROUND OF THE INVENTION

1. Field of the Invention

The invention relates to a circuit configuration compensating for disturbance variables for a measurement pickup having a measured-variable dependent resistance which additively comprises a fundamental resistance that is independent of measured variables, and a measuring resistance that is dependent on measured variables. The fundamental resistance and the measuring resistance are disturbance variable-dependent in opposite directions.

An example of such a measurement pickup is a GMR sensor (giant magneto-resistive). That sensor, like many sensors, is temperature dependent. Such a GMR sensor is described, for example, in the commonly assigned international publication WO 94/17426. The sensor changes its resistance on the basis of an external magnetic field.

In such measurement pickups with a measured-variable dependent resistance, the change in resistance is usually converted into a voltage swing or into a current change.

In the measurement pickups under consideration in this case, the measured-variable dependent resistance comprises two parts: a fundamental value, which is independent of measured variables, and the variable measuring resistance, which represents the response of the measurement pickup to the measured variable. In the case of the aforementioned GMR sensor, the fundamental value is independent of magnetic fields and the measuring resistance is dependent only on the direction of the magnetic field, within certain limits.

Nearly all of the measurement pickups are dependent on certain disturbance variables, however. An obvious example is, as mentioned, temperature. In the measurement pickups under consideration, both the fundamental resistance and the measuring resistance are dependent on disturbance variables, the disturbance variable dependency running in opposite directions. In the case of the aforementioned GMR sensor, the fundamental resistance increases with rising temperature and the magnetic field related change in the measuring resistance becomes smaller at the same time.

One possibility that is known from the prior art, of compensating for disturbance variable-dependency is to measure the disturbance variable and to correct the measured signal accordingly. In the case of temperature dependency, a temperature sensor is usually required for this. Furthermore, the disturbance variable-dependency, for example the temperature dependency, of the measurement pickup needs to be measured once and recorded in an appropriate correction characteristic curve. This entails considerable effort.

Japanese patent abstracts relating to JP 1-213179 A and JP 11118516 A disclose the practice of using a constant current source to apply a current to four magnetorestrictive elements in a bridge circuit and of tapping off the bridge voltage as the measured signal. In the constant current source, a thermal resistor is used which ensures that any temperature dependent sensitivity of the sensor elements contained in the bridge circuit is compensated for by a temperature dependent level of the constant current.

German published patent document DE 30 07 747 discloses a circuit configuration for a sensor in which, in addition to the sensor signal, a further signal is supplied. That further signal indicates the temperature of the sensor, and it is used for temperature compensation of the sensor.

### SUMMARY OF THE INVENTION

The object of the present invention is to provide a circuit configuration that compensates for disturbance variables for a measurement pickup of the aforementioned type which overcomes the above-noted deficiencies and disadvantages of the prior art devices and methods of this general kind, and which allows such compensation without requiring a measurement of the disturbance variable.

With the above and other objects in view there is provided, in accordance with the invention, a circuit configuration, comprising:

two measurement pickups each having a resistance dependent on measured variables, the resistance additively including a fundamental resistance independent of the measured variables, and a measuring resistance dependent on the measured variables, the fundamental resistance and the measuring resistance being disturbance variable-dependent in mutually opposite directions;

the two measurement pickups having mutually identical disturbance variable-dependency and being connected in a bridge circuit, with difference evaluation to eliminate the disturbance variable-dependency of the fundamental resistance; and

a bridge voltage controller connected to the bridge circuit for setting a bridge diagonal voltage in opposite direction to the disturbance variable dependency of the measuring resistance for eliminating the disturbance variable dependency of the measuring resistance.

In accordance with an added feature of the invention, the bridge circuit includes a first series circuit of a resistor and one of the measurement pickups connected in parallel with a second series circuit of a resistor and the other of the measurement pickups, a differential amplifier tapping off a potential of each of the first and second series circuits at a respective node between the resistor and the measurement pickup.

In accordance with another feature of the invention, the bridge circuit includes a parallel circuit comprising a respective the measurement pickup connected in series with a respective the resistor, and a differential amplifier is connected for tapping off a potential between the measurement pickups and the respective resistors in each case.

In accordance with an additional feature of the invention, the bridge voltage controller has an operational amplifier with an inverting input, a non-inverting input, and an output, the bridge circuit is connected in a negative feedback path of the operational amplifier such that the measurement pickups are connected in parallel in a feedback path, the inverting input of the operational amplifier connected to ground via a resistor, and the noninverting input connected to receive feedback from the output of the operational amplifier via a resistor.

In accordance with a further feature of the invention, a resistor in the negative feedback path of the operational amplifier is connected in series with the bridge circuit.

In accordance with a concomitant feature of the invention, a resistor is connected between a noninverting input of the differential amplifier to a reference voltage.

In other words, according to the invention, the measured signal change caused by a disturbance variable related resistance change in the fundamental resistance is eliminated by a bridge circuit and difference evaluation between two measurement pickups having identical disturbance variable dependency.

In addition, the disturbance variable influenced dependency of the measuring resistance is corrected by utilizing the disturbance variable-dependent change in the fundamental resistance for compensation purposes.

The advantage of this concept of the invention is that the additional components required in the prior art, such as temperature sensors or the like, can be dispensed with. Instead, the circuit configuration effects control on the basis of the real disturbance-variable or temperature response that is specific to the measurement pickups.

The invention thus derives unexpected advantage from an inherently known bridge circuit comprising the measurement pickups by virtue of the fact that not only is a disturbance variable dependent change in the fundamental resistance eliminated but also this elimination is used to compensate for the disturbance variable dependent change in the measuring resistance.

Other features which are considered as characteristic for the invention are set forth in the appended claims.

Although the invention is illustrated and described herein as embodied in a circuit configuration compensating for disturbance variables for a measurement pickup, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing shows a simplified circuit diagram for a circuit configuration compensating for disturbance variables according to the invention.

### DESCRIPTION OF THE PREFERRED EMBODIMENTS

Referring now to the sole FIGURE of the drawing in detail, the circuit configuration uses two measurement pickups which are dependent on disturbance variables. The pickups are two GMR sensors S1, S2 having a temperature-dependent resistance. The resistance additively comprises a fundamental resistance, which is independent of magnetic fields, and a measuring resistance, which is dependent on magnetic fields.

The sensors S1 and S2 are connected in parallel, each with a respective resistor R3 and R4 in series. These are further combined to form a bridge circuit. The potential is tapped off at a node in the series circuit between the sensor S1 and the resistor R3 and in the series circuit between the sensor S2 and the resistor R4 and is supplied via a respective resistor R9 and R10 to an operational amplifier OP2 connected up as a differential amplifier. The inverting feedback path of the op amp OP2 contains a resistor R7. A resistor R11 is connected from the noninverting input to a reference ground voltage Vref2. The resistors R9 and R10, R7 and R11 are identical in respective pairs; the ratio of R9 to R7 defines the gain ratio. Situated at the output of the operational amplifier OP2 is the signal output OUT, at which the voltage signal can be tapped off.

Since the two sensors S1 and S2 have the same temperature response and the operational amplifier OP2 connected up as a differential amplifier is used for difference evaluation, the temperature related changes in the fundamental resistance of the sensors S1, S2 cancel each other out. This eliminates the fundamental resistance and its temperature influence.

In addition, the bridge circuit comprising the sensors S1, S2 and the resistors R3, R4 is incorporated into the negative feedback path of an operational amplifier OP1 operating as a bridge voltage controller. In this case, the inverting input of the operational amplifier OP1 is connected to the node between the resistors R3 and R4, and the output of the operational amplifier OP1 is connected to the node between the sensors S1, S2, with another resistor R2 being interposed. In addition, the inverting input of the operational amplifier OP1 is connected to the reference-ground potential GND via a resistor R5.

The noninverting input of the operational amplifier OP1 receives feedback from the output of the operational amplifier OP1 via a resistor R6 and is at the same time connected to a reference voltage via a resistor R8.

The circuit works in the following manner: if the fundamental resistance of the sensors S1, S2 changes as a function of temperature, the current flowing into the bridge circuit causes a change in the voltage drop across the resistor bridge. This voltage drop is fed back to the positive input of the operational amplifier OP1 that operates as a bridge voltage controller such that an increase in the bridge voltage is established when the operational amplifier OP1 is in the steady state. The associated increase in the bridge diagonal voltage causes overdriving, which compensates for the temperature-related decrease in the measuring resistance of the sensors S1, S2.

The bridge voltage controller OP1 connected up as described thus controls the sensors S1, S2 on the basis of their specific temperature response and compensates for temperature related changes in the measuring resistance.

The voltage at the output OUT takes the reference voltage Vref2 as reference. Vref2 may be the reference ground potential GND.

In the case of components with unipolar supply, however, it is advantageous to put Vref2 at a higher level.

If the circuit shown in the FIGURE is not provided with a voltage signal output OUT but rather with a current output as a result of the insertion of a resistor, the bridge voltage increased to compensate for a temperature change can be used to raise Vref2 in order to compensate for the different current requirement of the circuit, caused by the changes in the bridge voltage and in the resistances of the sensors S1, S2, at the various temperatures. Thus, a separate current controller taking into account temperature changes during supply of the circuit is then superfluous.

We claim:

1. A circuit configuration, comprising:
two measurement pickups each having a resistance dependent on measured variables, the resistance additively including a fundamental resistance independent of the measured variables, and a measuring resistance dependent on the measured variables, the fundamental resistance and the measuring resistance being disturbance variable-dependent in mutually opposite directions;
said two measurement pickups having mutually identical disturbance variable-dependency and being connected in a bridge circuit, with difference evaluation to eliminate the disturbance variable-dependency of the fundamental resistance; and
a bridge voltage controller connected to said bridge circuit for setting a bridge diagonal voltage in opposite direction to the disturbance variable dependency of the measuring resistance for eliminating the disturbance variable dependency of the measuring resistance.

2. The circuit configuration according to claim 1, wherein said bridge circuit includes a first series circuit of a resistor and one of said measurement pickups connected in parallel with a second series circuit of a resistor and the other of said measurement pickups, a differential amplifier tapping off a potential of each of said first and second series circuits at a respective node between said resistor and said measurement pickup.

3. The circuit configuration according to claim 2, wherein said bridge voltage controller has an operational amplifier with an inverting input, a non-inverting input, and an output, said bridge circuit is connected in a negative feedback path of said operational amplifier such that said measurement pickups are connected in parallel in a feedback path, said inverting input of said operational amplifier connected to ground via a resistor, and said noninverting input connected to receive feedback from said output of said operational amplifier via a resistor.

4. The circuit configuration according to claim 3, which comprises a resistor in the negative feedback path of said operational amplifier connected in series with said bridge circuit.

5. The circuit configuration according to claim 2, which comprises a resistor connected between a noninverting input of said differential amplifier to a reference voltage.

6. The circuit configuration according to claim 1, wherein the bridge circuit includes a parallel circuit comprising a respective said measurement pickup connected in series with a respective said resistor, and a differential amplifier is connected for tapping off a potential between the measurement pickups and said respective resistors in each case.

7. The circuit configuration according to claim 6, wherein said bridge voltage controller has an operational amplifier with an inverting input, a non-inverting input, and an output, said bridge circuit is connected in a negative feedback path of said operational amplifier such that said measurement pickups are connected in parallel in a feedback path, said inverting input of said operational amplifier connected to ground via a resistor, and said noninverting input connected to receive feedback from said output of said operational amplifier via a resistor.

8. The circuit configuration according to claim 7, which comprises a resistor in the negative feedback path of said operational amplifier connected in series with said bridge circuit.

9. The circuit configuration according to claim 6, which comprises a resistor connected between a noninverting input of said differential amplifier to a reference voltage.
